(19) United States
(12) Patent Application Publication
(10) Pub. No.: US 2009/0023016 A1
(43) Pub. Date: Jan. 22, 2009

(54) Perpendicular magnetic recording medium

(76) Inventors: Kiwamu Tanahashi, Tokyo (JP); Ichiro Tamai, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/218,683

(22) Filed: Jul. 16, 2008

(30) Foreign Application Priority Data
Jul. 17, 2007 (JP) 2007-186086

(51) Int. Cl. G11B 5/66; B32B 37/00

(52) U.S. Cl. 428/828.1; 156/272.4

(57) ABSTRACT

Embodiments of the present invention help to provide a perpendicular magnetic recording medium in which a perpendicular magnetic recording layer is formed via a soft magnetic under-layer on a disk substrate, whereby the error rate is reduced and high density recording is enabled. According to one embodiment, the disk substrate is textured so that the center line average height (Ra) is from 0.05 nm to 0.2 nm, in which the soft magnetic under-layer is amorphous and has a film thickness from 2.5 nm to 10 nm, and the magnetic field for saturation (Hs) of the perpendicular magnetic recording layer is 7 kOe or less.

### CROSS-REFERENCE TO RELATED APPLICATION

The instant nonprovisional patent application claims priority to Japanese Patent Application No. 2007-186086 filed Jul. 17, 2007 and which is incorporated by reference in its entirety herein for all purposes.

### BACKGROUND OF THE INVENTION

In recent years, magnetic disk units have been built into home information appliances, as well as personal computers or a servers, whereby there is a growing demand for smaller size and larger capacity. However, as the areal recording density of the magnetic disk unit is increased and the recording bit size is smaller, a so-called thermal decay problem has emerged where magnetically recorded data disappears after some years due to influence of environmental heat. Therefore, in the conventional longitudinal magnetic recording system, it may be difficult to realize the areal recording density of 100 gigabits or more per square inch.

On the other hand, the perpendicular magnetic recording system, unlike the longitudinal magnetic recording system, has the property that as the linear recording density is increased, a demagnetizing field acting on the recording bits is decreased, so that the recording magnetization is kept stable. Further, since a strong head magnetic field is obtained by providing a soft magnetic under-layer (hereinafter abbreviated as an SUL) having a high permeability under the perpendicular magnetic recording layer, the coercive force of the perpendicular magnetic recording layer can be increased. For these reasons, the perpendicular magnetic recording system is considered effective in overcoming a thermal fluctuation limit of the longitudinal magnetic recording system.

The medium for use in the perpendicular magnetic recording system is mainly composed of an SUL that assists the recording head and a perpendicular magnetic recording layer that records and stores magnetic information. The perpendicular magnetic recording layer may be made of a material having a strong perpendicular magnetic anisotropy so that recording magnetization is arranged in a perpendicular direction to the film surface, in which each magnetic grain is magnetically isolated to attain high medium SNR. Specifically, a granular type material in which oxide such as SiO2 or TiO2 is added to the Co—Cr—Pt alloy is widely considered. On such a granular type perpendicular magnetic recording layer, since non-magnetic oxide forms a grain boundary to surround magnetic grains, a magnetic interaction between adjacent magnetic grains is reduced. Also, since the grain boundary of oxide suppresses coalescence of magnetic grains, there is a feature that the dispersion of grain size can be smaller than the conventional longitudinal magnetic recording medium of Cr-segregation type. The perpendicular magnetic recording medium having such a microstructure has a high medium SNR and an excellent thermal stability, with the possibility of contributing to the higher areal recording density.

However, if the magnetic interaction between adjacent magnetic grains is greatly reduced, there is a stronger tendency that each magnetic grain is independently reversed, increasing the dispersion of switching magnetic field. As a result, it is difficult to write data sufficiently. On the other hand, the recording head with trailing shield has been examined to improve the magnetic field gradient in a head running direction and increase the recording resolution. This type of recording head tends to have a lower recording magnetic field strength than the conventional magnetic monopole head. In such a situation, it is important that the perpendicular magnetic recording medium has a high medium SNR and an excellent thermal stability, and is easy to record data.

To meet this kind of demand for the perpendicular magnetic recording medium, a medium in which the perpendicular magnetic recording layer is composed of two or more magnetic layers, at least one layer contains Co as the main component, Pt and oxide, and at least one of the other layers contains Co as the main component and Cr and does not contain oxide has been proposed in Japanese Patent Publication No. 2004-310910, for example. By making the perpendicular magnetic recording layer such a layer organization, it is possible to have a high medium SNR and a high thermal stability, and improve the write characteristics.

On the other hand, for the SUL of the perpendicular magnetic recording medium, a so-called anti-parallel coupled (APC) SUL in which the soft magnetic layers are laid via a thin non-magnetic layer, and the magnetization of the upper and lower soft magnetic layers is anti-parallel coupled has been widely examined, as disclosed in Japanese Patent Publication No. 2001-331920, for example. Using this APC-SUL, it is possible to suppress spike-like noise caused by a magnetic domain wall of the soft magnetic layer. Also, an amorphous material such as CoTaZr, CoNbZr, or CoFeTaZr is used as the SUL material, whereby it is possible to suppress the surface roughness from increasing due to SUL formation. The flatness of the SUL surface has influence on the c-axis perpendicular orientation dispersion of the perpendicular magnetic recording layer formed via the non-magnetic intermediate layer thereon. Generally, as the flatness of the SUL surface is higher, the c-axis perpendicular orientation dispersion can be reduced, so that the high medium SNR is obtained.

The substrate used for the perpendicular magnetic recording medium, unlike the longitudinal magnetic recording medium, is not generally subjected to texture treatment. Herein, the texture treatment means the treatment for mechanically roughening the substrate surface using abrasive grains. The longitudinal magnetic recording medium is textured along the circumferential direction of the substrate, and given a uniaxial magnetic anisotropy with the easy axis of magnetization in the same direction, whereby there is an advantage that the medium SNR is improved. On the contrary, the perpendicular magnetic recording medium is usually formed with the perpendicular magnetic recording layer via the thick SUL having a film thickness of 100 nm or more, whereby the texture treatment has less influence on the perpendicular magnetic anisotropy of the perpendicular magnetic recording layer. Also, the uniaxial magnetic anisotropy with the easy axis of magnetization in the circumferential direction given to the SUL by the texture treatment in the circumferential direction of the substrate, competes with the uniaxial magnetic anisotropy with the easy axis of magnetization in the radial direction given to the SUL by a leakage magnetic field (radial direction of the substrate) from a sputter cathode in forming the SUL, consequently causing a dispersion in the in-plane magnetic anisotropy. For this reason, the substrate not subjected to texture treatment is generally employed for the perpendicular magnetic recording medium. As the exception, a method has been proposed in which uneven streaks oblique at angles of 45 degrees or more to the track direction (circumferential direction of the substrate) where information is recorded are formed by texture treatment and the SUL is formed while applying a magnetic field parallel to a direction (radial direction of the substrate) roughly orthogonal to the track direction, as disclosed in Japanese Patent Publication No. 2005-174393. In this way, a desired in-plane magnetic anisotropy can be given through the special texture treatment and the application of magnetic field in a direction different from the conventional circumferential direction.

To improve the areal recording density, it is required to increase both the linear recording density and the track density. As the track density is increased, the size of the recording head is smaller, whereby less magnetic flux is generated from the recording head during recording. Therefore, the film thickness of SUL can be principally made smaller in the range where the desired recording magnetic field is obtained. In the conventional thick amorphous (100 nm or greater) SUL, the presence or absence of the texture treatment for the substrate has less influence on the recording and reproducing characteristics of the perpendicular magnetic recording layer, but when the film thickness of the amorphous SUL is small, it is expected that there is a great influence of the texture treatment for the substrate.

### BRIEF SUMMARY OF THE INVENTION

Embodiments of the present invention help to provide a perpendicular magnetic recording medium in which a perpendicular magnetic recording layer is formed via a soft magnetic under-layer on a disk substrate, whereby the error rate is reduced and high density recording is enabled. According to one embodiment, the disk substrate is textured so that the center line average height (Ra) is from 0.05 nm to 0.2 nm, in which the soft magnetic under-layer is amorphous and has a film thickness from 2.5 nm to 10 nm, and the magnetic field for saturation (Hs) of the perpendicular magnetic recording layer is 7 kOe or less.

### BRIEF DESCRIPTION OF THE DRAWINGS

FIG. 1 is a view showing a layer structure example of a perpendicular magnetic recording medium according to an embodiment of the present invention.

FIGS. 2(a) and 2(b) are views showing an error rate of the perpendicular magnetic recording medium.

FIGS. 3(a) and 3(b) are views showing a c-axis orientation dispersion of the perpendicular magnetic recording medium.

FIGS. 4(a) and 4(b) are views showing a plan-view TEM image on a perpendicular magnetic recording layer of the perpendicular magnetic recording medium.

FIG. 5 is a view showing the relationship between the overwrite characteristic and the magnetic field for saturation in the perpendicular magnetic recording medium.

FIG. 6 is a view showing the relationship between the error rate and the magnetic field for saturation in the perpendicular magnetic recording medium.

### DETAILED DESCRIPTION OF THE INVENTION

Embodiments of the present invention relate to a perpendicular magnetic recording medium capable of recording large amounts of information.

Embodiments of the invention have been achieved in the light of the above-mentioned circumstances, and it is an object of embodiments of the invention to provide a perpendicular magnetic recording medium with a low error rate, capable of high density recording and excellent in manufacturability.

According to embodiments of the present invention, there is provided a perpendicular magnetic recording medium in which a perpendicular magnetic recording layer is formed via an SUL on a disk substrate. The disk substrate is textured on the surface along the circumferential direction, the center line average roughness (Ra) is 0.05 nm or more and 0.2 nm or less, the SUL is amorphous, and has a film thickness 2.5 nm or more and 10 nm or less, and part of grains of the perpendicular recording layer are arranged along the texture. The magnetic field for saturation (Hs) of the perpendicular magnetic recording layer is 7 kOe or less.

It is difficult and unrealistic with the texturing techniques at the mass production level to make Ra of the disk substrate below 0.05 nm. Also, it is undesirable that Ra is 0.3 nm or greater, because the c-axis orientation dispersion of the perpendicular magnetic recording layer is increased when the film thickness of the SUL is as thin as 2.5 nm ill or more and 10 nm or less. By making the magnetic field for saturation (Hs) of the perpendicular magnetic recording layer 7.0 kOe or less, it is possible to record with a head with trailing shield, even when the film thickness of the SUL is as thin as 2.5 nm or more and 10 nm or less, whereby it is possible to suppress a deterioration in the recording and reproducing characteristics due to a write failure.

With embodiments of the invention, a high c-axis orientation property of the perpendicular magnetic recording layer, as well as the arrangement of magnetic grains and the finer grain diameter, can be realized, so that it is possible to provide the perpendicular magnetic recording medium with low error rate, capable of high density recording and excellent in manufacturability.

A perpendicular magnetic recording medium according to embodiments of the present invention will be described below in detail with reference to the drawings.

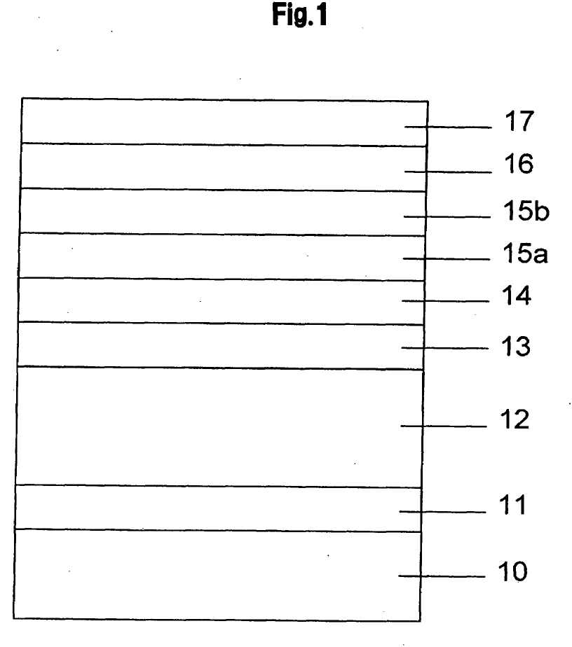

FIG. 1 is a view showing a layer structure example of the perpendicular magnetic recording medium according to an embodiment of the invention. This perpendicular magnetic recording medium has an adhesion layer 11, an SUL 12, a seed layer 13, an intermediate layer 14, a perpendicular magnetic recording layer 15, a protective layer 16, and a lubricating layer 17 which are successively formed on a substrate 10. The perpendicular magnetic recording layer 15 is composed of a first magnetic layer 15a and a second magnetic layer 15b. This perpendicular magnetic recording medium was fabricated using a sputtering apparatus (C-3040) made by Canon Anelva. For the substrate 10, ten kinds of glass substrates were used in which texture treatment was present or absent and the surface roughness was adjusted, as shown in Table 1. The texture treatment was made along the circumferential direction of the substrate. The surface roughness was adjusted by changing the size of abrasive grain used in the texture treatment.

TABLE 1

| Substrate # | Texture treatment | Ra (nm) |
|---|---|---|
| 1 | None | 0.4 |
| 2 | None | 0.3 |
| 3 | None | 0.2 |
| 4 | None | 0.1 |
| 5 | None | 0.05 |
| 6 | Present | 0.4 |
| 7 | Present | 0.3 |
| 8 | Present | 0.2 |
| 9 | Present | 0.1 |
| 10 | Present | 0.05 |

The adhesion layer 11 was formed with an Al—Ti alloy film having a thickness of 5 nm, the SUL 12 was formed with a film in which two layers of amorphous Fe—Co—Ta—Zr alloy film having a thickness of 1.25 nm to 30 nm were laid via an Ru film having a thickness of 0.4 nm, the seed layer was formed with a laminated film of a Cr—Ti alloy film having a thickness of 2 nm and an Ni—W alloy film having a thickness of 9 nm, the intermediate layer 14 was formed with an Ru film having a thickness of 17 nm, the first magnetic layer 15a was formed with a Co—Cr—Pt—SiO₂ alloy film having a thickness of 13 nm, the second magnetic layer 15b was formed with a Co—Cr—Pt—B alloy film having a thickness of 8 nm, and the protective layer 16 was formed with a carbon film of 4 nm. Herein, the first magnetic layer 15a was formed by a reactive sputtering method in a mixed gas of argon and oxygen, and the protective layer 16 was formed by an RF-CVD method. The lubricating layer 17 was formed by coating perfluoro-alkyl-polyether material. Table 2 shows the composition of sputtering target used as the target of each layer.

TABLE 2

| | Target composition |
|---|---|
| Adhesion layer | Al-50 at % Ti |
| Soft magnetic under-layer | Fe-34 at % Co-10 at % Ta-5 at % Zr |
| | Ru |
| | Fe-34 at % Co-10 at % Ta-5 at % Zr |
| Seed layer | Cr-50 at % Ti |
| | Ni-8 at % W |
| Intermediate layer | Ru |
| First magnetic layer | 92 mol % (Co-17 at % Cr-18 at % Pt)- |
| | 8 mol % SiO2 |
| Second magnetic layer | Co-15 at % Cr-14 at % Pt-8 at % B |

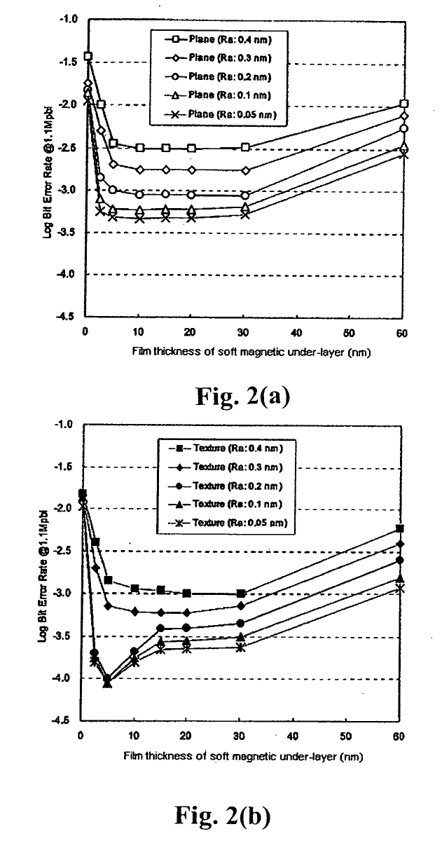

FIGS. 2(a) and 2(b) are views showing an error rate of the fabricated perpendicular magnetic recording medium. A magnetic head used in this evaluation was a typical head with trailing shield, in which the track width of a recording head was 90 nm, and the track width of a reproducing head was 70 nm. The error rate was evaluated by recording and reproducing a pseudo-random pattern at a linear recording density of 1.1 MBPI, using a recording and reproducing evaluation instrument (RH4160) made by Hitachi DECO. FIG. 2A shows the results of evaluation in the case of using the substrate without texture treatment (plane substrate) and FIG. 2B shows the results of evaluation in the case of using the texture substrate.

In the comparison between substrate species, the excellent error rate was obtained in the case of using the texture substrate, and the error rate was improved as Ra was smaller, irrespective of the substrate species. As for the SUL film thickness dependency, the almost constant error rate was obtained in the range from 5 nm to 30 nm in the case of the plane substrate, whereas the SUL film thickness dependency was varied depending on the size of Ra in the case of the texture substrate. Specifically, when Ra was in the range from 0.05 nm to 0.2 nm, the especially excellent error rate was obtained in the range of SUL film thickness from 2.5 nm to 10 nm. The coercive force (Hc) of the fabricated perpendicular magnetic recording medium was in the range from 4.15 to 4.37 kOe, and the magnetic field for saturation (Hs) was in the range from 6.85 to 6.97 kOe.

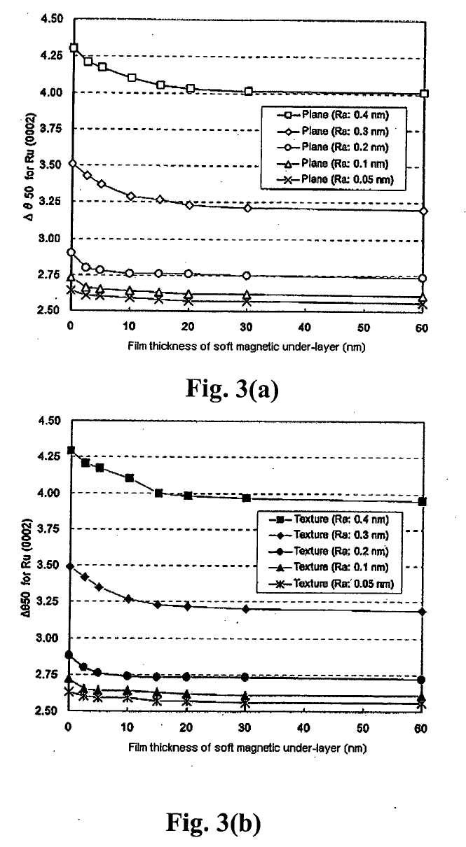

FIGS. 3(a) and 3(b) are views showing a c-axis orientation dispersion of the fabricated perpendicular magnetic recording medium. In this evaluation, a rocking curve at Ru (0002) diffraction peak of the intermediate layer in the epitaxial relationship with the perpendicular magnetic recording layer was measured, and Δθ50 obtained thereby was used as an index of the c-axis perpendicular orientation dispersion of the perpendicular magnetic recording layer. FIG. 3A shows the results of evaluation in the case of using the plane substrate and FIG. 3B shows the results of evaluation in the case of using the texture substrate.

Irrespective of the substrate species, as Ra was smaller, Δθ50 was smaller, that is, the c-axis perpendicular orientation dispersion was smaller. In the comparison between substrate species, when Ra was as large as 0.4 nm, slightly smaller Δθ50 was obtained in the texture substrate, but the difference was negligibly smaller than a change of Δθ50 with Ra. As for the SUL film thickness dependency, there was the similar tendency irrespective of the substrate species, and in the case where Ra was relatively large at 0.3 nm or more, there was a tendency that Δθ50 increased when the SUL film thickness was smaller than 10 nm. However, in the case where Ra was as small as 0.2 nm or less, sufficiently small Δθ50 was obtained, even when the SUB film thickness was as small as 2.5 nm. That is, it was shown that if Ra was made as small as 0.2 nm or less, irrespective of the substrate species, a deterioration in the c-axis perpendicular orientation dispersion caused by making the amorphous SUL thinner could be suppressed.

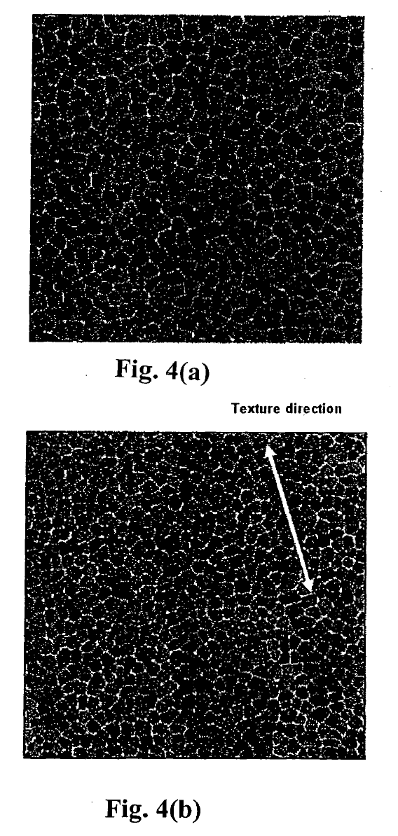

FIGS. 4(a) and 4(b) are views showing a plane TEM image on the perpendicular magnetic recording layer of the fabricated perpendicular magnetic recording medium. Herein, the plane substrate and the texture substrate had a small Ra of 0.1 nm and the SUL film thickness was 5 nm. In the plane substrate as shown in FIG. 4A, there is no regularity in the arrangement of magnetic grains, whereas in the texture substrate as shown in FIG. 4B, a portion where magnetic grains grow along the texture is seen as indicated by the arrow, in which it can be found that the texture has influence on the growth of magnetic grains. In comparison, the average crystal grain diameter was 9.5 mm in the plane substrate, whereas it was as fine as 8.0 nm in the texture substrate. Even when Ra was 0.05 nm at minimum in the texture substrate, the arrangement of magnetic grains along the texture was seen in the range of SUL film thickness of 10 nm or less, whereby the finer grain diameter by 10 to 15% than the plane substrate was confirmed.

The difference in the error rate as shown in FIGS. 2(a) and 2(b) with the substrate species, the difference with Ra, and the difference with SUL film thickness will be considered based on the results as shown in FIGS. 3(a)-3(b) and 4(a)-4(b). First of all, it is required to make the c-axis perpendicular orientation dispersion as small as possible to obtain the excellent error rate. In this regard, Ra reduction of the substrate is effective, as shown in FIGS. 3(a) and 3(b). The Ra dependency of the error rate can be explained by the change of the c-axis perpendicular orientation dispersion. However, the results in which the more excellent error rate was obtained at the same Ra level in the texture substrate of the two different substrate species can not be explained by only the c-axis perpendicular orientation dispersion. Thus, if it is assumed that the “effect of magnetic grain arrangement and finer grain diameter” as seen in the texture substrate contributes as another factor to improvement in the error rate, as shown in FIGS. 4(a) and 4(b), not only the difference with the substrate species but also the difference with the SUL film thickness can be explained well. That is, if Ra was 0.2 nm or less in the texture substrate, the effect of magnetic grain arrangement and finer grain diameter was enhanced, while maintaining the low c-axis perpendicular orientation dispersion in the range of SUL film thickness from 2.5 nm to 10 nm, so that the error rate could be specially improved. On the other hand, if Ra was 0.3 nm or greater in the texture substrate, the c-axis perpendicular orientation dispersion was increased in the range of SUL film thickness of 10 nm or less, and the effect of magnetic grain arrangement and finer grain diameter was offset, so that the error rate could not be specially improved. Also, if Ra was 0.2 nm or less in the plane substrate, the specially improved error rate could not be obtained in the range of SUL film thickness of 10 nm or less, because there was no effect of magnetic grain arrangement and finer grain diameter.

As described above, it is effective for improving the error rate that the texture substrate has Ra of 0.05 nm or more and 0.2 nm or less and the amorphous SUL film thickness is 2.5 nm or more and 10 nm or less.

The perpendicular magnetic recording medium was fabricated through the same procedure as above. For the substrate 10, three kinds of substrate textured along the circumferential direction were used in which the surface roughness Ra was adjusted to be 0.2 nm, 0.1 nm and 0.05 nm. The adhesion layer 11 was formed with an Al—Ti alloy film having a thickness of 5 nm, the SUL 12 as formed with a film in which two layers of Fe—Co—Ta—Zr alloy film having a thickness of 1.25 nm to 5 nm were laid via an Ru film having a thickness of 0.4 nm, the seed layer was formed with a laminated film of a Cr—Ti alloy film having a thickness of 2 nm and an Ni—W—Cr alloy film having a thickness of 9 nm, the intermediate layer 14 was formed with an Ru film having a thickness of 17 nm, the first magnetic layer 15a was formed with a Co—Cr—Pt—SiO₂ alloy film having a thickness of 11 nm or 13 nm, the second magnetic layer 15b was formed with a Co—Cr—Pt—B alloy film having a thickness of 6 nm to 8 nm, and the protective layer 16 was formed with a carbon film of 4 nm. Herein, the first magnetic layer 15a was formed by a reactive sputtering method in a mixed gas of argon and oxygen, and the protective layer 16 was formed by an RF-CVD method. The lubricating layer 17 was formed by coating perfluoro-alkyl-polyether material. Table 3 shows the composition of sputtering target used as the target of each layer.

TABLE 3

| | Target composition |
|---|---|
| Adhesion layer | Al-50 at % Ti |
| Soft magnetic under-layer | Fe-34 at % Co-10 at % Ta-5 at % Zr |
| | Ru |
| | Fe-34 at % Co-10 at % Ta-5 at % Zr |
| Seed layer | Cr-50 at % Ti |
| | Ni-6 at % W-8 at % Cr |
| Intermediate layer | Ru |
| First magnetic layer | 92 mol % (Co-19 at % Cr-18 at % Pt)- |
| | 8 mol % SiO₂ |
| Second magnetic layer | Co-15 at % Cr-14 at % Pt-8 at % B |

Table 4 is a view showing the coercive force, the magnetic field for saturation, the overwrite characteristic and the error rate of the fabricated perpendicular magnetic recording medium. A magnetic head used in this evaluation was a typical head with a trailing shield, in which the track width of a recording head was 90 nm, and the track width of a reproducing head was 70 nm. The overwrite characteristic was evaluated by overwriting a signal of 114kFCI on a signal of 689kFCI, and in terms of a strength ratio of extinctive component of 689kFCI to the signal of 114kFCI. The error rate was evaluated by recording and reproducing a pseudo-random pattern at a linear recording density of 1.1 MBPI, using a recording and reproducing evaluation instrument (RH4160) made by Hitachi DECO.

TABLE 4

| | | | First | Second | | | | |
|---|---|---|---|---|---|---|---|---|
| | | | magnetic | magnetic | Coer- | Magnetic | | |
| | | SUL film | layer film | layer film | cive | field for | Overwrite | |
| Sample | Ra | thickness | thickness | thickness | force | saturation | character- | log |
| # | (nm) | (nm) | (nm) | (nm) | (kOe) | (kOe) | istic (dB) | BER |
| 1 | 0.2 | 10 | 13 | 6 | 4.58 | 7.57 | −19.0 | −2.1 |
| 2 | 0.2 | 10 | 13 | 7 | 4.35 | 7.10 | −25.0 | −3.0 |
| 3 | 0.2 | 10 | 13 | 8 | 4.15 | 6.87 | −31.0 | −3.8 |
| 4 | 0.2 | 10 | 11 | 6 | 4.45 | 7.26 | −21.2 | −2.2 |
| 5 | 0.2 | 10 | 11 | 7 | 4.31 | 6.97 | −30.8 | −3.8 |
| 6 | 0.2 | 10 | 11 | 8 | 4.00 | 6.54 | −33.0 | −3.8 |
| 7 | 0.2 | 2.5 | 13 | 6 | 4.70 | 7.69 | −18.0 | −2.0 |
| 8 | 0.2 | 2.5 | 13 | 7 | 4.47 | 7.19 | −22.0 | −2.7 |
| 9 | 0.2 | 2.5 | 13 | 8 | 4.27 | 6.97 | −30.5 | −3.8 |
| 10 | 0.2 | 2.5 | 11 | 6 | 4.57 | 7.31 | −20.9 | −2.2 |
| 11 | 0.2 | 2.5 | 11 | 7 | 4.43 | 6.99 | −30.5 | −3.8 |
| 12 | 0.2 | 2.5 | 11 | 8 | 4.12 | 6.57 | −32.8 | −3.9 |
| 13 | 0.1 | 10 | 13 | 6 | 4.82 | 7.67 | −18.3 | −2.1 |
| 14 | 0.1 | 10 | 13 | 7 | 4.59 | 7.20 | −22.1 | −3.1 |
| 15 | 0.1 | 10 | 13 | 8 | 4.39 | 6.97 | −30.4 | −3.9 |
| 16 | 0.1 | 10 | 11 | 6 | 4.69 | 7.37 | −21.0 | −2.3 |
| 17 | 0.1 | 10 | 11 | 7 | 4.55 | 6.98 | −30.7 | −3.8 |
| 18 | 0.1 | 10 | 11 | 8 | 4.24 | 6.64 | −33.0 | −3.9 |
| 19 | 0.1 | 2.5 | 13 | 6 | 4.94 | 7.81 | −17.5 | −2.0 |
| 20 | 0.1 | 2.5 | 13 | 7 | 4.71 | 7.29 | −22.2 | −2.7 |
| 21 | 0.1 | 2.5 | 13 | 8 | 4.51 | 6.99 | −30.2 | −3.8 |
| 22 | 0.1 | 2.5 | 11 | 6 | 4.81 | 7.42 | −20.2 | −2.2 |
| 23 | 0.1 | 2.5 | 11 | 7 | 4.67 | 7.00 | −30.2 | −3.8 |
| 24 | 0.1 | 2.5 | 11 | 8 | 4.36 | 6.67 | −32.9 | −4.0 |
| 25 | 0.05 | 10 | 13 | 6 | 5.06 | 7.80 | −17.8 | −2.1 |
| 26 | 0.05 | 10 | 13 | 7 | 4.83 | 7.33 | −20.5 | −2.4 |
| 27 | 0.05 | 10 | 13 | 8 | 4.63 | 6.99 | −30.3 | −3.8 |
| 28 | 0.05 | 10 | 11 | 6 | 4.93 | 7.50 | −19.5 | −2.2 |
| 29 | 0.05 | 10 | 11 | 7 | 4.79 | 7.11 | −25.0 | −3.2 |
| 30 | 0.05 | 10 | 11 | 8 | 4.48 | 6.77 | −32.2 | −3.8 |
| 31 | 0.05 | 2.5 | 13 | 6 | 5.18 | 7.94 | −17.0 | −2.0 |
| 32 | 0.05 | 2.5 | 13 | 7 | 4.95 | 7.41 | −20.0 | 2.3 |
| 33 | 0.05 | 2.5 | 13 | 8 | 4.75 | 7.00 | −30.1 | −3.8 |
| 34 | 0.05 | 2.5 | 11 | 6 | 5.05 | 7.55 | −19.0 | −2.2 |
| 35 | 0.05 | 2.5 | 11 | 7 | 4.91 | 7.12 | −25.3 | −3.2 |
| 36 | 0.05 | 2.5 | 11 | 8 | 4.60 | 6.78 | −31.2 | −3.9 |

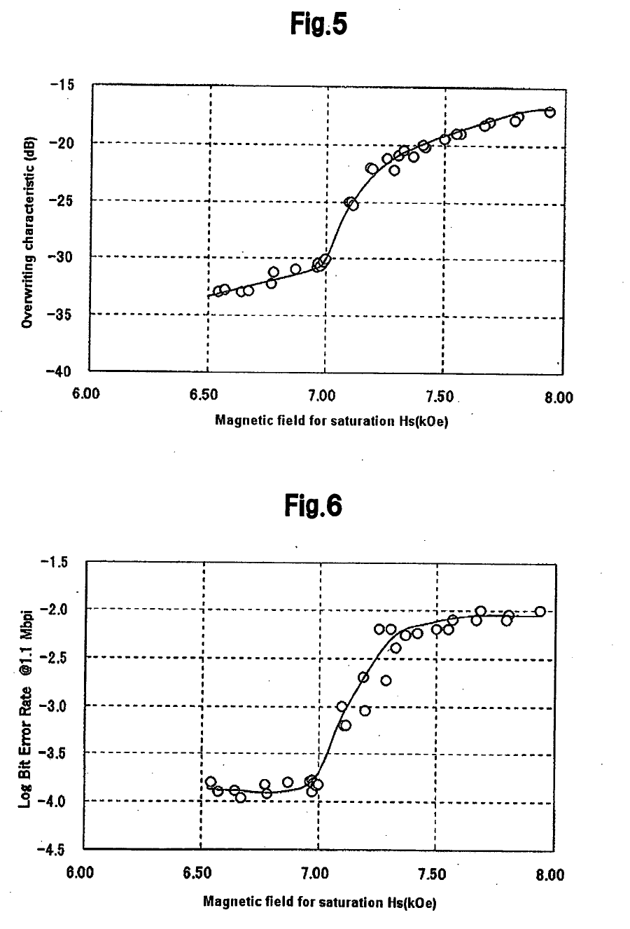

FIG. 5 is a view showing the relationship between the overwrite characteristic and the magnetic field for saturation in the fabricated perpendicular magnetic recording medium. If the magnetic field for saturation was 7 kOe or less, the excellent overwrite characteristic of −30 dB or less could be obtained. That is, if the SUL film thickness is as small as from 2.5 nm or more and 10 nm or less, the sufficient write can be achieved by making the magnetic field for saturation on the perpendicular magnetic recording layer 7 kOe or less.

FIG. 6 is a view showing the relationship between the error rate and the magnetic field for saturation in the fabricated perpendicular magnetic recording medium. If the magnetic field for saturation was 7 kOe or less, the sufficient write could be made, whereby the excellent error rate was obtained. If the magnetic field for saturation was 7 kOe or greater, the error rate was deteriorated due to a write failure.

As described above, in the perpendicular magnetic recording medium in which the SUL film thickness is 2.5 nm or more and 10 nm or less, if the magnetic field for saturation on the perpendicular magnetic recording layer is 7 kOe or less, sufficient write can be made by the typical recording head with a trailing shield, effectively improving the error rate.

What is claimed is:

1. A perpendicular magnetic recording medium in which a perpendicular magnetic recording layer is formed via a soft magnetic under-layer on a disk substrate, characterized in that said disk substrate is textured along the circumferential direction, the center line average roughness (Ra) is from 0.05 nm to 0.2 nm, said soft magnetic under-layer is amorphous, and has a film thickness from 2.5 nm to 10 nm, and the magnetic field for saturation (Hs) of said perpendicular magnetic recording layer is 7 kOe or less.

2. The perpendicular magnetic recording medium according to claim 1, wherein an adhesion layer, the soft magnetic under-layer, a seed layer, an intermediate layer, the perpendicular magnetic recording layer, a protective layer, and a lubricating layer are successively formed on the disk substrate.

3. The perpendicular magnetic recording medium according to claim 2, wherein the adhesion layer is formed with an Al—Ti alloy film having a thickness of 5 nm.

4. The perpendicular magnetic recording medium according to claim 1, wherein the soft under-layer is formed with a film having two layers of amorphous Fe—Co—Ta—Zr alloy film.

5. The perpendicular magnetic recording medium according to claim 2, wherein the seed layer is formed with a laminated film of a Cr—Ti alloy film having a thickness of 2 nm and an Ni—W alloy film having a thickness of 9 nm.

6. The perpendicular magnetic recording medium according to claim 2, wherein the intermediate layer is formed with an Ru film having a thickness of 17 nm.

7. The perpendicular magnetic recording medium according to claim 1, wherein the perpendicular magnetic recording layer includes a first magnetic layer formed with a Co—Cr—Pt—SiO₂ alloy film having a thickness of 13 nm, and a second magnetic layer formed with a Co—Cr—Pt—B alloy film having a thickness of 8 nm.

8. The perpendicular magnetic recording medium according to claim 2, wherein the protective layer is formed with a carbon film of 4 nm.

9. The perpendicular magnetic recording medium according to claim 2, wherein the lubricating layer is formed by coating perfluoro-alkyl-polyether material.

10. A method for forming a perpendicular magnetic recording medium comprising:
forming an adhesion layer a disk substrate;
forming a soft magnetic under-layer on the adhesion layer,
forming a seed layer on the soft magnetic under-layer;
forming an intermediate layer on the seed layer;
forming a perpendicular magnetic recording layer on the intermediate layer,
forming a protective layer on the perpendicular magnetic recording layer, and
forming a lubricating layer on the protective layer;
wherein the disk substrate is textured along the circumferential direction and the center line average roughness (Ra) is from 0.05 nm to 0.2 nm,
wherein the said soft magnetic under-layer is amorphous and has a film thickness from 2.5 nm to 10 nm,
wherein the magnetic field for saturation (Hs) of said perpendicular magnetic recording layer is 7 kOe or less.

11. The method according to claim 10, wherein the adhesion layer is formed with an Al—Ti alloy film having a thickness of 5 nm.

12. The method according to claim 10, wherein the soft under-layer is formed with a film having two layers of amorphous Fe—Co—Ta—Zr alloy film.

13. The method according to claim 10, wherein the seed layer is formed with a laminated film of a Cr—Ti alloy film having a thickness of 2 nm and an Ni—W alloy film having a thickness of 9 nm.

14. The method according to claim 10, wherein the intermediate layer is formed with an Ru film having a thickness of 17 nm.

15. The method according to claim 10, wherein the perpendicular magnetic recording layer includes a first magnetic layer formed with a Co—Cr—Pt—SiO₂ alloy film having a thickness of 13 nm, and a second magnetic layer formed with a Co—Cr—Pt—B alloy film having a thickness of 8 nm.

16. The method according to claim 10, wherein the protective layer is formed with a carbon film of 4 nm.

17. The method according to claim 10, wherein the lubricating layer is formed by coating a perfluoro-alkyl-polyether material.
